(19) United States
(12) Patent Application Publication
(10) Pub. No.: US 2009/0074932 A1
(43) Pub. Date: Mar. 19, 2009

(54) PROTEIN-FORTIFIED FROZEN DESSERT FORMULATION AND PROCESS

(76) Inventors: Robert Swan, Guelph (CA); Christopher Delaney, Burlington (CA); Amanda House, Burlington (CA)

Correspondence Address: BERESKIN AND PARR, 40 KING STREET WEST, BOX 401, TORONTO, ON, M5H 3Y2, CA

(21) Appl. No.: 12/158,422

(22) PCT Filed: Dec. 20, 2006
(86) PCT No.: PCT/CA2006/002076

§ 371 Date: Oct. 28, 2008

Related U.S. Application Data
(60) Provisional application No. 60/752,916, filed on Dec. 23, 2005.
(60) Provisional application No. 60/774,203, filed on Feb. 17, 2006.

(51) Int. Cl. A23G 9/38; A23G 9/30

(52) U.S. Cl. 426/522; 426/580

(57) ABSTRACT

A protein-fortified frozen dessert formulation and the process for making it are described. In particular, a sweet mix of 10-20% w/w sugar, 0-10% w/w flavouring, 0-20% w/w fat, 10-15% w/w milk solids, 0-11% w/w protein and 50-65% w/w water is prepared, preheated, pasteurized, homogenized and aged. The aged sweet-mix is then blended with yogurt and optionally more protein prior to freezing. Alternatively, a mix of 10-20% w/w sugar, 0-10% w/w flavouring, 0-20% w/w fat, 10-15% w/w milk solids, 5-15% w/w protein, 5-20% yogurt and 50-65% w/w water is prepared, preheated, pasteurized, homogenize and aged and frozen to a low target overrun.

### FIELD OF THE INVENTION

The invention relates to a frozen dessert formulation and process. In particular, the invention relates to a frozen dessert formulation that has been fortified with protein.

### BACKGROUND OF THE INVENTION

Frozen yogurt is typically formulated to a protein level of 2-4 percent weight per volume (% w/v). Protein fortification to higher levels presents significant processing challenges, in that product mixes become excessively viscous and, consequently, difficult to pump and heat-process.

There are various examples in the art of attempts at creating a protein-fortified yogurt. For example, U.S. Pat. No. 4,837,036 to Baker et al. discloses a low fat thin-bodied yogurt that has high protein content. However, such a formulation is not likely to result in a finished product with a creamy texture/mouthfeel and taste. U.S. Pat. No. 4,258,064 to Michener, Jr. discloses preparation of a non-fat naturally sweet yogurt and discloses that one object of the invention is to provide a high protein, low calorie yogurt product but does not describe the formulation used to achieve this. U.S. Pat. No. 4,110,476 to Rhodes discloses the preparation of both liquid and frozen yogurt products. The process used to produce this formulation first creates a liquid yogurt, which is designed to be a beverage, which optionally can be frozen into a soft-serve yogurt. Rhodes' method relies on the use of microcrystalline cellulose to stabilize the blend. The inclusion of microcrystalline cellulose may be perceived as undesirable by health conscious consumers. US Patent Publication No. 2005/0129835 to Delahanty discloses high protein content food supplement which can be modified to a frozen yogurt. This product is designed to be a supplement and contains protein at undesirably high levels that would not offer the desired flavour of a frozen yogurt dessert. Contrary to what the patent states, frozen yogurt formulations with this level of whey protein, particularly hydrolyzed whey protein, are likely to have a bitter, objectionable flavour. Furthermore, this formula is likely to result in a highly viscous product that is difficult to pasteurize using traditional pasteurization methods. A mix that is this viscous will wear out pumps, mixers, etc. There is likely to be product build-up & burn-on during batch or continuous pasteurization. A product that is this thick is likely to entrain air which would likely lead to pumping problems. According to this patent, a sponge or dough is formed by wetting the dry ingredients with just enough water to result in this consistency; this method requires the use of high torque mixers not commonly found in frozen novelty manufacturing plants. A mixing time of 20 minutes, as described, is not a good fit for high volume production facilities where speed and efficiency of mix preparation is critical.

In view of the foregoing, there remains a need in the art to create a protein-fortified dessert formulation designed for making a frozen dessert product.

### SUMMARY OF THE INVENTION

The present inventors have developed a process that allows the production of a protein-fortified frozen dessert. Accordingly, the present invention provides a process for making a protein-fortified frozen dessert formulation comprising

(a) preparing a sweet mix comprising 10-20% w/w sugar, 0-10% w/w flavouring, 0-20% w/w fat, 10-15% w/w milk solids, 0-11% w/w protein and 50-65% w/w water;

(b) preheating the sweet mix to 30-60° C.;

(c) pasteurizing the preheated sweet mix;

(d) homogenizing the pasteurized preheated sweet mix;

(e) cooling to 3-5° C. for 4-16 hours to produce an aged sweet mix;

(f) preparing a final mix of 0-20% w/w yogurt, 70-90% w/w of the aged sweet mix; and 0-10% w/w protein; and

(g) freezing the final mix to prepare a protein-fortified frozen dessert formulation.

The invention also provides a process where all of the ingredients are added prior to pasteurization. Accordingly, in another embodiment, the invention provides a process for making a protein-fortified frozen dessert formulation comprising

(a) preparing a mix comprising 5-25% w/w sugar, 0-10% w/w flavouring, 0-20% w/w fat, 0-15% w/w milk solids, 0-20% w/w protein, 0-25% yogurt and 0-65% w/w water;

(b) preheating the mix to 30-60° C.;

(c) pasteurizing the preheated mix;

(d) homogenizing the pasteurized preheated mix;

(e) cooling the mix to 3-5° C. for 4-16 hours to produce an aged mix; and

(f) freezing the aged mix to prepare a protein-fortified frozen dessert formulation.

In another embodiment, the process further comprises freezing in step (f) to a target overrun of 25-55%. The invention further provides the protein-fortified frozen dessert formulation produced by the processes of the invention.

The invention also provides a protein-fortified frozen dessert formulation comprising 8-15% w/w sugar, 0-8% w/w flavouring, 2-15% w/w fat, 8-12% w/w milk solids, 5-20% w/w protein, 5-20% w/w yogurt, 39-50% w/w water and 20%-55% v/v air.

In another embodiment, the invention provides a protein-fortified frozen dessert formulation comprising 10-20% w/w sugar, 0-10% w/w flavouring, 0-20% w/w fat, 10-15% w/w milk solids, 5-15% w/w protein, 5-20% yogurt, 50-65% w/w water and 10-40% v/v air.

In another embodiment, the yogurt ingredient is replaced by additional milk solids, fat or protein.

Other features and advantages of the present invention will become apparent from the following detailed description. It should be understood, however, that the detailed description and the specific examples while indicating preferred embodiments of the invention are given by way of illustration only, since various changes and modifications within the spirit and scope of the invention will become apparent to those skilled in the art from this detailed description.

### DESCRIPTION OF THE INVENTION

The present invention provides a protein-fortified frozen dessert formulation and process for making protein-fortified frozen dessert food products. Atypical processing methods, such as extended mixing times, post-pasteurization ingredient addition, and lower target overruns were used to achieve finished product protein targets.

The formulations of the present invention have been fortified with whey protein resulting in a total protein content of 9-13% w/v. The term “protein-fortified frozen dessert” as used herein is understood to mean having a final protein content of at least 5% w/v, preferably in the range of 8-15% w/v. The person skilled in the art would appreciate that the total protein content can be calculated from the protein component, milk solids and yogurt component of the final product.

Accordingly, the present invention provides a process for making a protein-fortified frozen dessert formulation comprising

(a) preparing a sweet mix comprising 10-20% w/w sugar, 0-10% w/w flavouring, 0-20% w/w fat, 10-15% w/w milk solids, 0-11% w/w protein and 50-65% w/w water;

(b) preheating the sweet mix to 30-60° C.;

(c) pasteurizing the preheated sweet mix;

(d) homogenizing the pasteurized preheated sweet mix;

(e) cooling to 3-5° C. for 4-16 hours to produce an aged sweet mix;

(f) preparing a final mix of 0-20% w/w yogurt, 70-90% w/w of the aged sweet mix; and 0-10% w/w protein; and

(g) freezing the final mix to prepare a protein-fortified frozen dessert formulation.

In one embodiment, the preparation of the final mix in step (f) comprises blending the yogurt and aged sweet mix at 5,000 to 7,000 rpms followed by the addition of protein at 9,000 to 10,000 rpms.

In yet another particular embodiment, the sweet mix comprises about 19% w/w sugar, about 3% w/w flavouring, about 4% w/w fat, about 10% w/w milk solids; about 10% w/w protein and about 54% w/w water. In another particular embodiment, the final mix comprises about 14% w/w yogurt, about 77% w/w aged sweet mix and about 9% w/w protein. In yet another particular embodiment, the final mix comprises about 15% w/w yogurt, 85% w/w aged sweet mix and about 0% w/w protein.

A person skilled in the art would understand that post pasteurization, only ingredients that have been pre-screened and certified, by lot code, as having met established microbial, physical and compositional standards that ensure finished product safety and performance should be used.

Addition of yogurt post-pasteurization provides the benefit of live yogurt cultures in the finished product. Such products have been shown to promote good digestion and health.

Alternatively, the inventors have used a lower target overrun to produce a protein-fortified frozen dessert formulation where the yogurt is added pre-pasteurization.

Accordingly, the invention provides a process for making a protein-fortified frozen dessert formulation comprising:

(a) preparing a mix comprising 5-25% w/w sugar, 0-10% w/w flavouring, 0-20% w/w fat, 0-15% w/w milk solids, 0-20% w/w protein, 0-25% yogurt and 0-65% w/w water;

(b) preheating the mix to 30-60° C.;

(c) pasteurizing the preheated mix;

(d) homogenizing the pasteurized preheated mix;

(e) cooling the mix to 3-5° C. for 4-16 hours to produce an aged mix; and

(f) freezing the aged mix to prepare a protein-fortified frozen dessert formulation.

In another embodiment, the process further comprises freezing in step (f) to a target overrun of 25-55%. Percent target overrun as used herein means [(Volume of Frozen Yogurt—Volume Of Mix)/Volume Of Mix]×100%.

A person skilled in the art would understand that in preparing the mix, all ingredients may be mixed together or dry ingredients may be blended separately from the liquid ingredients prior to mixing all ingredients.

In a particular embodiment, the mix in step (a) comprises 10-20% w/w sugar, 0-10% w/w flavouring, 0-20% w/w fat, 10-15% w/w milk solids, 5-15% w/w protein, 5-20% yogurt and 50-65% w/w water. In a more particular embodiment, the mix in step (a) comprises about 19% w/w sugar, about 3% w/w flavouring, about 2% w/w fat, about 7% w/w milk solids, about 11% w/w protein, about 14% yogurt and about 45% w/w water.

In one embodiment, the homogenizing in step (d) of the processes of the invention is a one-stage or two-stage homogenization. In a particular embodiment, the two-stage homogenization is at 2000-2500 PSI, followed by homogenizing at 500-1000 PSI. In a more particular embodiment, the two-stage homogenization is at 2000 PSI followed by 500 PSI. In another particular embodiment, the one stage homogenization is at 2000-3000 PSI.

A person skilled in the art would understand that preheating is necessary to fully solubilize ingredients prior to pasteurization. Typically, the mix is brought to the solubilization temperature with the pasteurization process commenced immediately thereafter. In a particular embodiment, the mix is preheated to 55° C.

The term “pasteurization” as used herein means the process of heating food for the purpose of killing harmful organisms such as bacteria, viruses, protozoa, molds and yeast. In one embodiment, pasteurizing is by batch pasteurization or continuous pasteurization. Temperatures for pasteurization of milk ingredients are typically below boiling point. There is not a range per se that needs to be used but rather a time/temperature continuum—as the temperature increases the hold time decreases and vice versa. In a particular embodiment, batch pasteurization is at 69° C. for 30 minutes or any other temperature and time combination that results in the product being pasteurized. In another particular embodiment, continuous pasteurization is at 80° C. for 25 seconds or any other temperature and time combination that results in the product being pasteurized.

A person skilled in the art would be able to choose the appropriate sugar based on the desired flavouring. In one embodiment, the sugar is selected from the group consisting of granulated sucrose, liquid sucrose, honey, corn syrup, corn syrup solids, high fructose corn syrup, glucose syrup, invert sugar, aspartame, sucralose, xylitol, sorbitol, maple syrup, sweetened fruit preserves, fruit puree, fruit, mallitol, maltitol and steveoside (Stevia)). In a particular embodiment, the sugar is granulated sucrose.

The desired flavour of the finished product will determine what flavouring is used. In one embodiment, the flavouring is selected from the group consisting of cocoa, maple, spices, such as allspice, cloves, nutmeg, cinnamon, ginger and mint, chocolate liquor, liqueurs such as almond, cherry, mint, Irish cream, coffee, strawberry, hazelnut, melon, orange, butterscotch, chocolate mint, amaretto, grand marnier and licorice, natural and artificial flavours. In a particular embodiment, the flavouring is cocoa. In another particular embodiment, the natural and artificial flavours produce a final flavour of vanilla, strawberry, butterscotch or chocolate.

The fat may be butter, but could be provided by the milk ingredient. Accordingly, in one embodiment, the fat is selected from the group consisting of butter, cream, whole milk, whole milk powder, anhydrous milk fat, omega fatty acids, and fat replacers. Omega fatty acids may be derived from canola oil, flax seed oil, flax powder, flax seeds, olive oil, walnut oil, soybean oil and fish oils. In a particular embodiment, the fat is butter.

The milk solids chosen will affect the final fat content of the product. A person skilled in the art would understand that for products with a desired low fat content, the milk solids would come from skim milk or buttermilk. In one embodiment, the milk solids are any type of milk. In another embodiment, the milk solids are selected from the group consisting of skim milk powder, skim milk, whole milk, whole milk powder, cream, soy milk, lactose-free milk, buttermilk and buttermilk powder. In a particular embodiment, the milk solids come from the skim milk powder.

The protein component may be any protein. The protein may be selected from the group consisting of whey protein, milk protein, casein, albumin, vegetable protein and soy protein. In one embodiment, the whey protein is whey protein concentrate, whey protein isolate or hydrolyzed whey protein. In another embodiment, the milk protein is milk protein concentrate, milk protein isolate or hydrolyzed milk protein. In yet another embodiment, the soy protein is soy protein concentrate, soy protein isolate or hydrolyzed soy protein. A person skilled in the art would understand that if the protein ingredient in step (a) above is at 0%, the formulation would be protein-fortified by using the upper ranges of the milk solids or yogurt ingredients, which would provide the necessary protein content.

A person skilled in the art would understand that whey is the by-product of the cheese-making process. Whey protein concentrate is manufactured by filtering out significant quantities of lactose, minerals and water from whey by means of an ultrafiltration process resulting in a protein concentrated liquid that is then spray dried into a powder form. Hydrolyzed whey protein, also referred to as whey protein hydrolyzate, is produced by a controlled enzymatic treatment of whey prior to further processing resulting in a specific amino acid/peptide/polypeptide profile.

The water added to the formulation may also come from other liquids. In one embodiment, the water is added in the form of moisture from liquid dairy ingredients or liquid sweeteners.

The yogurt used in the processes of the invention may be any yogurt. In one embodiment, the yogurt is selected from the group consisting of low fat yogurt, full fat yogurt, freeze dried yogurt culture, frozen yogurt culture, yogurt acid flavouring and yogurt solids. Alternatively, live yogurt cultures, such as Streptococcus thermophilus, Lactobacillus bulgaricus and Lactobacillus acidophilus, may be added directly to the product mix pre- or post-pasteurization. In another embodiment, yogurt is replaced by additional milk solids, fat and/or protein to provide a process for making a protein-fortified frozen dessert. A person skilled in the art would readily understand the conversion of yogurt to milk solids, fat and/or protein.

A person skilled in the art would understand that additional ingredients may be added. For example, emulsifiers, such as mono- and di-glycerides, egg yolk and Polysorbate 80 may be added to the mix at a usage level of 0-1% w/w. Stabilizers such as locust bean gum, guar gum, carboxymethyl cellulose, xanthan gum, sodium alginate and carrageenan may be added at a usage level of 0-0.04% w/w. Caffeine, vitamins, minerals, amino acids, creatine, probiotics, herbs, health supplements or any other additives may also be added but usage of these ingredients are understood to be limited by the bitterness and other off flavours that they impart to the finished product.

Where possible or available, ingredients used in the processes and formulations of the invention may be organic.

The processes of the present invention are used to make protein-fortified frozen dessert products, in particular frozen yogurt products. A person skilled in the art would understand that the inclusion of other products used in regular frozen yogurt and ice cream could be introduced into the final mix. Such products include chocolate chips, caramel, bubblegum, a variety of nuts, fruits and vegetables and baked inclusions such as cookies, brownies, pie crust pieces, wafer pieces, sugar cone pieces; cookie dough; candies; chocolate bar pieces; crunches.

### Formulations:

The invention further provides a protein-fortified frozen yogurt or frozen dessert formulation produced by the processes of the invention.

The invention also provides a protein-fortified frozen dessert formulation comprising 8-15% w/w sugar, 0-8% w/w flavouring, 2-15% w/w fat, 8-12% w/w milk solids, 5-20% w/w protein, 0-20% w/w yogurt, 39-50% w/w water and 20%-55% v/v air.

In a particular embodiment, the invention provides a protein-fortified frozen dessert formulation comprising about 15% w/w sugar, about 2% w/w flavouring, about 3% w/w fat, about 8% w/w milk solids, about 17% w/w protein, about 14% w/w yogurt, about 42% w/w water and about 41% v/v air.

In another embodiment, the invention provides a protein-fortified frozen dessert formulation comprising 5-25% w/w sugar, 0-10% w/w flavouring, 0-20% w/w fat, 0-15% w/w milk solids, 0-20% w/w protein, 0-25% yogurt, 0-65% w/w water and 0-55% v/v air. In a particular embodiment, the invention provides a protein-fortified frozen dessert formulation comprising 10-20% w/w sugar, 0-10% w/w flavouring, 0-20% w/w fat, 10-15% w/w milk solids, 5-15% w/w protein, 5-20% yogurt, 50-65% w/w water and 10-40% v/v air.

In a more particular embodiment, the protein fortified frozen dessert formulation comprises about 19% w/w sugar, about 3% w/w flavouring, about 2% w/w fat, about 7% w/w milk solids, about 11% w/w protein, about 14% yogurt, about 45% w/w water and 0-55% v/v air. In another particular, embodiment, % v/v air is about 0%, about 13%, about 20% or about 25%. A person skilled in the art would understand that the amount of air incorporated depends on the type of dessert product desired. For example, a frozen novelty would likely have little air incorporated, whereas a frozen dessert in a tub would be expected to have about 25 to 35% v/v air.

A person skilled in the art would be able to choose the appropriate sugar based on the desired flavouring. In one embodiment, the sugar is selected from the group consisting of granulated sucrose, liquid sucrose, honey, corn syrup, corn syrup solids, high fructose corn syrup, glucose syrup, invert sugar, aspartame, sucralose, xylitol, sorbitol, maple syrup, sweetened fruit preserves, fruit puree, fruit, mallitol, maltitol and steveoside (Stevia)). In a particular embodiment, the sugar is granulated sucrose.

A person skilled in the art would readily be able to choose the flavouring based on the desired end flavour of the product. In one embodiment, the flavouring is selected from the group consisting of cocoa, maple, spices, such as allspice, cloves, nutmeg, cinnamon, ginger and mint, chocolate liquor, liqueurs such as almond, cherry, mint, Irish cream, coffee, strawberry, hazelnut, melon, orange, butterscotch, chocolate mint, amaretto, grand marnier and licorice, natural and artificial flavours. In a particular embodiment, the flavouring is cocoa. In another particular embodiment, the natural and artificial flavours produce a final flavour of vanilla, strawberry, butterscotch or chocolate.

The fat may be butter, but could be provided by the milk ingredient. Accordingly, in one embodiment, the fat is selected from the group consisting of butter, cream, whole milk, whole milk powder, anhydrous milk fat, omega fatty acids, and fat replacers. Omega fatty acids may be derived from canola oil, flax seed oil, flax powder, flax seeds, olive oil, walnut oil, soybean oil and fish oils. In a particular embodiment, the fat is butter.

The milk solids chosen will affect the final fat content of the product. A person skilled in the art would understand that for products with a desired low fat content, the milk solids would come from skim milk or buttermilk. In one embodiment, the milk solids are any type of milk. In another embodiment, the milk solids are selected from the group consisting of skim milk powder, skim milk, whole milk, whole milk powder, cream, soy milk, lactose-free milk, buttermilk and buttermilk powder. In a particular embodiment, the milk solids come from the skim milk powder.

The protein component may be any protein. The protein may be selected from the group consisting of whey protein, milk protein, casein, albumin, vegetable protein and soy protein. In one embodiment, the whey protein is whey protein concentrate, whey protein isolate or hydrolyzed whey protein. In another embodiment, the milk protein is milk protein concentrate, milk protein isolate or hydrolyzed milk protein. In yet another embodiment, the soy protein is soy protein concentrate, soy protein isolate or hydrolyzed soy protein. A person skilled in the art would understand that if the protein ingredient is at 0%, the formulation would be protein-fortified by using the upper ranges of the milk solids or yogurt ingredients, which would provide the necessary protein content.

The water in the formulation may also come from other liquids. In one embodiment, the water is in the form of moisture from liquid dairy ingredients or liquid sweeteners.

The yogurt may be any yogurt. In one embodiment, the yogurt is selected from the group consisting of low fat yogurt, full fat yogurt, freeze dried yogurt culture, frozen yogurt culture, yogurt acid flavouring and yogurt solids. Alternatively, live yogurt cultures, such as Streptococcus thermophilus, Lactobacillus bulgaricus and Lactobacillus acidophilus, may be added directly to the product mix pre- or post-pasteurization. In another embodiment, yogurt is replaced by additional milk solids, fat and/or protein to provide a process for making a protein-fortified frozen dessert. A person skilled in the art would readily understand the conversion of yogurt to milk solids, fat and/or protein.

A person skilled in the art would understand that the formulation may comprise additional ingredients. For example, emulsifiers, such as mono- and di-glycerides, egg yolk and Polysorbate 80 may be included in the formulation at a usage level of 0-1% w/w. Stabilizers such as locust bean gum, guar gum, carboxymethyl cellulose, xanthan gum, sodium alginate and carrageenan may be included at a usage level of 0-0.04% w/w. Caffeine, vitamins, minerals, amino acids, creatine, probiotics, herbs, health supplements or any other additives may also be added but usage of these ingredients are understood to be limited by the bitterness and other off flavours that they impart to the finished product.

The formulations of the present invention are used to make protein-fortified frozen dessert, and in a particular aspect, frozen yogurt products. A person skilled in the art would understand that the inclusion of other products used in regular frozen yogurt and ice cream could be introduced into the formulation. Such products include chocolate chips, caramel, bubblegum, a variety of nuts, fruits and vegetables and baked inclusions such as cookies, brownies, pie crust pieces, wafer pieces, sugar cone pieces; cookie dough; candies; chocolate bar pieces; crunches.

Formulations of the invention can be used to produce dessert products such as protein-fortified frozen dessert sandwiches, protein-fortified frozen dessert in a tub, protein-fortified frozen dessert novelties, protein-fortified frozen dessert drumsticks, protein-fortified frozen dessert cakes, protein-fortified frozen dessert sundaes, protein-fortified soft serve frozen dessert, protein-fortified milkshakes and protein-fortified smoothies. In a particular aspect, these dessert products are made with frozen yogurt. All of these products could be made available for both the retail and food service sectors.

The following non-limiting examples are illustrative of the present invention:

### EXAMPLE

### Example 1

### Processes—Live Yogurt Cultures

The manufacture of the frozen yogurt formulations consisted of:

1. Sweet Mix Preparation
Individual ingredients were weighed or metered to the prescribed quantity.
Dry ingredients (sugar, cocoa, skim milk powder, whey protein concentrate and/or whey protein hydrolyzate) were dry blended until evenly mixed; i.e. hand blended in a plastic bag for approximately 2 minutes.
The dry blend was slowly added (over approximately 5 minutes) to the prescribed quantity of water (20-25° C.) while mixing using a high-speed mixer (a Silverson L4RT lab mixer) at 9000-10,000 revolutions per minute (rpms). Mixing continued for an additional 1-2 minutes at 9000 rpms until the dry ingredients were fully solubilized.
The mix was pre-heated to 55° C. using a pilot-scale, high temperature/short time (HTST), shell and tube pasteurizer followed by pasteurization at 80° C. for 27 seconds, two-stage homogenization at 2000 PSI (1^{st} stage)+500 PSI (2^{nd} stage), and in-line cooling to 4° C.

2. Sweet Mix Ageing
The pasteurized/homogenized mix was maintained at 4° C. for a minimum of 12 hours to ensure full hydration of the dairy proteins.

3. Final Mix Preparation
The prescribed quantity of low fat yogurt was blended into the aged sweet mix at a mixing speed of 5000-7,000 rpms over a total mixing time of 1 minute.
For the frozen yogurt sandwich and frozen yogurt in a tub only—the prescribed quantity of whey protein concentrate was blended into the sweet mix+yogurt blend at a mixing speed of 9,000-10,000 rpms over a total mixing time of 5 minutes.

4. Mix Freezing/Final Product Generation
For the frozen novelty:
   The final mix was poured directly into product moulds (125 mL) Different sized product moulds could also be used.
   The product was partially frozen for approximately 2 minutes in a blast freezer at −33° C., at which point a wooden frozen novelty stick was inserted into the centre of the product.
   Freezing continued for a minimum of 24 hours at −33° C. until the final product was fully frozen.
For the frozen sandwich:
   The final mix was processed into frozen yogurt using a pilot-scale soft serve ice cream machine (Taylor Freezer).
   The mix was processed to 70% overrun over a 12 minute time period and at a draw temperature of −4.9° C.
   soft serve frozen yogurt was collected directly off the Taylor Freezer into product moulds, lined on the bottom with chocolate wafers, to approximately a 2″ depth required for the targeted finished product volume of 200 mL. An additional layer of chocolate wafers was placed, by hand, on top of the still soft frozen yogurt to form a frozen yogurt sandwich.
   The final product was plastic wrapped and hardened in a blast freezer at −33° C. for a minimum of 24 hours.
For the frozen yogurt in a tub
   The final mix was processed to 70% overrun over a 12 minute time period at a draw temperature of −4.9° C. using the Taylor soft serve ice cream machine.
   The final product was collected directly off the Taylor freezer into 1 litre plastic tubs. A plastic lid was applied by hand to each tub.
   The final product was hardened in a blast freezer at −33° C. for a minimum of 24 hours.

### Key Ingredients

Two types of whey protein were used in this project for protein fortification:

### 1) Whey Protein Concentrate

Description: A spray-dried, soluble milk protein manufactured from fresh food grade whey using an ultrafiltration process.
Properties: Excellent emulsifying capabilities, used in protein fortification, low viscosity before heating.
Composition (as per supplier specification): Protein (80% w/w), Moisture (4.6% w/w), Fat (4.6% w/w), Carbohydrate (8.0% w/w), Ash (3.4% w/w)

### 2) Whey Protein Hydrolyzate

Description: An enzymatically hydrolyzed whey protein concentrate.
Properties: Excellent nutritional quality with low viscosity and good dispersibility
Composition (as per supplier specification): Protein (87.4% w/w), Moisture (4.0% w/w), Fat (2.8% w/w), Carbohydrate (<1.0% w/w), Ash (2.6% w/w).

### Formulations—for Product by Process

Sweet mix, final mix, and final product formulations varied depending on the desired final frozen yogurt product. In each case, ingredient usage levels and ranges, as well as potential substitutions are provided.

1) Frozen Yogurt Sandwich

| | | | |
|---|---|---|---|
| | Target | Usage | |
| | Usage | Range | |
| Ingredients | (% w/w) | (% w/w) | Alternate Ingredients |

Sweet Mix:

| | | | |
|---|---|---|---|
| Sucrose, | 18.75 | 10-20 | Liquid sucrose, honey, corn |
| granulated | | | syrup, corn syrup solids, |
| | | | high fructose corn syrup, |
| | | | glucose, aspartame, |
| | | | sucralose, xylitol, sorbitol, |
| | | | invert sugar, sweetened fruit |
| | | | preserves, and steveoside. |
| Cocoa, | 3.00 | 0-10 | Natural or artificial flavours, |
| unsweetened, | | | chocolate liquor |
| with alkali | | | |
| Butter, | 3.72 | 0-20 | Cream, whole milk, whole |
| unsalted | | | milk powder, anhydrous |
| | | | milk fat, fat replacers |
| Skim milk | 10.00 | 10-15 | Skim milk, whole milk, |
| powder, low | | | whole milk powder, cream, |
| temperature | | | buttermilk, buttermilk |
| | | | powder |
| Whey | 10.60 | 0-11 | Whey protein concentrate, |
| protein | | | whey protein isolate, whey |
| hydrolyzate | | | powder, milk proteins, soy |
| | | | proteins |
| Water | 53.93 | 50-65 | Moisture from liquid dairy |
| | | | ingredients and/or liquid |
| | | | sweeteners |
| Total | 100.00 | | |

Final Mix:

| | | | |
|---|---|---|---|
| Sweet mix | 77.33 | | |
| Whey | 9.02 | 0-10 | Whey protein hydrolyzate, |
| protein | | | whey protein isolate, whey |
| concentrate | | | powder, milk proteins, soy |
| | | | proteins |
| Yogurt, low- | 13.65 | 5-20 | Yogurt, full-fat; yogurt |
| fat | | | solids, live yogurt cultures |
| Total | 100.00 | | |

| | | |
|---|---|---|
| | Target | |
| | Usage | Usage Range |
| Ingredients | (% v/v) | (% v/v) |

Final Product: (120 mL serving)

| | | |
|---|---|---|
| Final mix | 39.24 | 30-55 |
| Air* (incorporated | 27.46 | 15-35 |
| during freezing) | | |
| Wafer | 33.30 | 30-35 |
| Total | 100.00 | |

Final Product: (200 mL serving)

| | | |
|---|---|---|
| Final mix | 47.07 | 35-65 |
| Air* (incorporated | 32.95 | 15-45 |
| during freezing) | | |
| Wafer | 19.98 | 18-22 |
| Total | 100.00 | |

Final Product: (to be spread on any suitable wafer):

| | | |
|---|---|---|
| Final mix | 58.82 | 45-80 |
| Air* (incorporated | 41.18 | 20-55 |
| during freezing) | | |
| Total | 100.00 | |

*Based on a target overrun of 70% and an overrun range of 25%-120%

2) Frozen Yogurt In A Tub

| | | | |
|---|---|---|---|
| | Target | Usage | |
| | Usage | Range | |
| Ingredients | (% w/w) | (% w/w) | Alternate Ingredients |

Sweet Mix:

| | | | |
|---|---|---|---|
| Sucrose, | 18.75 | 10-20 | Liquid sucrose, honey, corn |
| granulated | | | syrup, corn syrup solids, |
| | | | high fructose corn syrup, |
| | | | glucose, aspartame, |
| | | | sucralose, xylitol, sorbitol, |
| | | | invert sugar, sweetened fruit |
| | | | preserves, steveoside |
| Cocoa, | 3.00 | 0-10 | Natural or artificial flavours, |
| unsweetened, | | | chocolate liquor |
| with alkali | | | |
| Butter, | 3.72 | 0-20 | Cream, whole milk, whole |
| unsalted | | | milk powder, anhydrous |
| | | | milk fat, fat replacers |
| Skim milk | 10.00 | 10-15 | Skim milk, whole milk, |
| powder, low | | | whole milk powder, cream, |
| temperature | | | buttermilk, buttermilk |
| | | | powder |
| Whey | 10.60 | 0-11 | Whey protein concentrate, |
| protein | | | whey protein isolate, whey |
| hydrolyzate | | | powder, milk proteins, soy |
| | | | proteins |
| Water | 53.93 | 50-65 | Moisture from liquid dairy |
| | | | ingredients and/or liquid |
| | | | sweeteners |
| Total | 100.00 | | |

Final Mix:

| | | | |
|---|---|---|---|
| Sweet mix | 77.33 | | |
| Whey | 9.02 | 0-10 | Whey protein hydrolyzate, |
| protein | | | whey protein isolate, whey |
| concentrate | | | powder, milk proteins, soy |
| | | | proteins |
| Yogurt, low- | 13.65 | 5-20 | Yogurt, full-fat; yogurt |
| fat | | | solids, live yogurt cultures |
| Total | 100.00 | | |

Final Product:

| | Target | |
|---|---|---|
| | Usage | Usage Range |
| Ingredients | (% v/v) | (% v/v) |
| Final mix | 58.82 | 45-80 |
| Air* (incorporated | 41.18 | 20-55 |
| during freezing) | | |
| Total | 100.00 | |

*Based on a target overrun of 70% and an overrun range of 25%-120%

3) Frozen Chocolate Yogurt Novelty

| | | | |
|---|---|---|---|
| | Target | Usage | |
| | Usage | Range | |
| Ingredients | (% w/w) | (% w/w) | Alternate Ingredients |

Sweet Mix:

| | | | |
|---|---|---|---|
| Sucrose, | 18.75 | 10-20 | Liquid sucrose, honey, corn |
| granulated | | | syrup, corn syrup solids, |
| | | | high fructose corn syrup, |
| | | | glucose, aspartame, |
| | | | sucralose, xylitol, sorbitol, |
| | | | invert sugar, sweetened fruit |
| | | | preserves, steveoside |
| Cocoa, | 3.00 | 0-10 | Natural or artificial flavours, |
| unsweetened, | | | chocolate liquor |
| with alkali | | | |
| Butter, | 3.72 | 0-20 | Cream, whole milk, whole |
| unsalted | | | milk powder, anhydrous |
| | | | milk fat, fat replacers |
| Skim milk | 10.00 | 10-15 | Skim milk, whole milk, |
| powder, low | | | whole milk powder, cream, |
| temperature | | | buttermilk, buttermilk |
| | | | powder |
| Whey | 10.60 | 0-11 | Whey protein concentrate, |
| protein | | | whey protein isolate, whey |
| hydrolyzate | | | powder, milk proteins, soy |
| | | | proteins |
| Water | 53.93 | 50-65 | Moisture from liquid dairy |
| | | | ingredients and/or liquid |
| | | | sweeteners |
| Total | 100.00 | | |

Final Mix:

| | | | |
|---|---|---|---|
| Sweet mix | 85.00 | | |
| Yogurt, low- | 15.00 | 5-20 | Yogurt, full-fat; yogurt |
| fat | | | solids, live yogurt cultures |
| Total | 100.00 | | |

This product is packed without air incorporation.

### Formulations—(Proportions in Final Product):

| | Target | Usage | |
|---|---|---|---|
| | Usage | Range | |
| | (% | (% | |
| Ingredients | w/w) | w/w) | Alternate Ingredients |
| Sucrose, | 14.50 | 8-15 | Liquid sucrose, honey, corn syrup, |
| granulated | | | corn syrup solids, high fructose |
| | | | corn syrup, glucose, aspartame, |
| | | | sucralose, xylitol, sorbitol, invert |
| | | | sugar, sweetened fruit preserves, |
| | | | steveoside |
| Cocoa, | 2.32 | 0-8 | Natural or artificial flavours, |
| unsweetened, | | | chocolate liquor |
| with alkali | | | |
| Butter, | 2.88 | 2-15 | Cream, whole milk, whole milk |
| unsalted | | | powder, anhydrous milk fat, fat |
| | | | replacers |
| Skim milk | 7.73 | 8-12 | Skim milk, whole milk, whole milk |
| powder, low | | | powder, cream, buttermilk, |
| temperature | | | buttermilk powder |
| Whey | 8.20 | 0-9 | Whey protein concentrate, whey |
| protein | | | protein isolate, whey powder, milk |
| hydrolyzate | | | proteins, soy proteins |
| Whey | 9.03 | 0-10 | Whey protein hydrolyzate, whey |
| protein | | | protein isolate, whey powder milk |
| concentrate | | | proteins, soy proteins |
| Yogurt, low- | 13.65 | 5-20 | Yogurt, full-fat; yogurt solids, live |
| fat | | | yogurt cultures |
| Water | 41.70 | 39-50 | Moisture from liquid dairy |
| | | | ingredients and/or liquid |
| | | | sweeteners |
| Total | 100.00 | | |

*Air incorporated during freezing to a target of 41% v/v, and to a range of 20%-55%, based on a target overrun of 70% and an overrun range of 25%-120%. For the novelty product, a lower target overrun would be appropriate.

### Example #2

### Process—Yogurt Added Pre-Pasteurization

The manufacture of each of the newly developed products—i.e. frozen yogurt novelty, frozen yogurt sandwich, and frozen yogurt in a tub—consisted of:
1. Mix Preparation
   Individual ingredients were weighed or metered to the prescribed quantity.
   Dry ingredients (cocoa, skim milk powder, whey protein concentrate and whey protein hydrolysate) were dry blended until evenly mixed; i.e. hand blended in a plastic bag for approximately 2 minutes.
   Liquid ingredients (liquid invert sugar and water) were heated to 25-35° C. and hand blended until uniform (approximately 2 minutes).
   The dry blend was added over approximately 2 minutes to the liquid blend (25-35° C.) while hand mixing using a whisk. Mixing continued until the dry ingredients were fully solubilized.
   Melted, unsalted butter and yogurt were added directly to the above blend and whisked until uniformly distributed (approximately 2 minutes).
   The mix was pre-heated to 55° C. using a pilot-scale, high temperature/short time (HTST), shell and tube pasteurizer followed by pasteurization at 80° C. for 27 seconds, two-stage homogenization at 2000 PSI (1^{st} stage)+500 PSI (2^{nd} stage), and in-line cooling to 4° C.
2. Mix Ageing
   The pasteurized/homogenized mix was maintained at 4° C. for a minimum of 12 hours to ensure full hydration of the dairy proteins.
3. Mix Freezing/Final Product Generation
   For the frozen yogurt novelty (i.e. fudge bar):
      The final mix was poured directly into product moulds (75 mL) without air incorporation (i.e. no overrun).
      The product was partially frozen for approximately 2 minutes in a blast freezer at −33° C., at which point a wooden frozen novelty stick was inserted into the centre of the product.
      Freezing continued for a minimum of 24 hours at −33° C. until the final product was fully frozen.
   For the frozen yogurt sandwich:
      The final mix was processed into frozen yogurt using a pilot-scale continuous freezer to a targeted overrun of 25%. Note:

$$\% overrun = \frac{Volume of Frozen Dessert - Volume of Mix}{Volume of Mix} \times 100 \%$$

Soft serve frozen yogurt was collected directly off the pilot-scale continuous freezer and used to fill product moulds to a volume of 80 mL.
The moulded frozen yogurt was hardened in a blast freezer at −33° C. for a approximately 1 hour, and then re-warmed in 30° C. water in order to release the frozen yogurt from the mould.
Final assembly of the frozen yogurt sandwich involved positioning one chocolate wafer on the top and one on the underside of the moulded frozen yogurt.
The final product was packaged in plastic overwrap and returned to the blast freezer for further hardening at −33° C. for a minimum of 24 hours.
For the frozen yogurt in a tub
   The final mix was processed into frozen yogurt using a pilot-scale continuous freezer to a targeted overrun of 35%.
   The final product was collected directly off the continuous freezer into 1 pint paper board tubs. A paper board lid was applied by hand to each tub.
   The final product was hardened in a blast freezer at −33° C. for a minimum of 24 hours.

### Formulations

Mix and final product formulations are presented as follows for each product.

In each case, ingredient usage levels and ranges, as well as potential substitutions are given.

1) Frozen Yogurt Sandwich
Mix:

| | Target | Usage | |
|---|---|---|---|
| | Usage | Range | |
| Ingredients | (% w/w) | (% w/w) | Alternate Ingredients |
| Medium | 19.00 | 0-25 | Liquid sucrose, honey, corn |
| invert sugar, | | | syrup, corn syrup solids, high |
| liquid | | | fructose corn syrup, glucose, |
| | | | aspartame, sucralose, xylitol, |
| | | | sorbitol, invert sugar, |
| | | | sweetened fruit preserves, |
| | | | steveoside |
| Cocoa, | 2.61 | 0-10 | Natural or artificial flavours, |
| unsweetened, | | | chocolate liquor |
| with alkali | | | |
| Butter, | 1.42 | 0-20 | Cream, whole milk, |
| unsalted | | | anhydrous milk fat, fat |
| | | | replacers, vegetable oils |
| Skim milk | 7.00 | 0-15 | The liquid, concentrated and |
| powder, low | | | dry forms of: skim milk, whole |
| temperature | | | milk, cream, buttermilk, whey, |
| | | | whey isolate and vegetable |
| | | | proteins including soy. |
| Whey | 5.84 | 0-15 | The liquid, concentrated and |
| Protein | | | dry forms of: skim milk, whole |
| Concentrate | | | milk, cream, buttermilk, whey, |
| | | | whey isolate and vegetable |
| | | | proteins including soy. |
| Whey | 5.84 | 0-15 | The liquid, concentrated and |
| Protein | | | dry forms of: skim milk, whole |
| Hydrolysate | | | milk, cream, buttermilk, whey, |
| | | | whey isolate and vegetable |
| | | | proteins including soy. |
| Yogurt, low- | 13.65 | 0-25 | Yogurt, full-fat; yogurt solids, |
| fat | | | and yogurt cultures such as |
| | | | Streptococcus thermophilus, |
| | | | Lactobacillus bulgaricus and |
| | | | Lactobacillus acidophilus |
| Water | 44.63 | 0-65 | Moisture from liquid dairy |
| | | | ingredients, liquid protein |
| | | | concentrates and/or liquid |
| | | | sweeteners |
| Total | 100.00 | | |

| | | | |
|---|---|---|---|
| | | Intermediate | |
| | Target | Usage | |
| | Usage | range | Usage Range |
| Ingredients | (% v/v) | (% v/v) | (% v/v) |

Final Product: (This formula is based on 120 mL.)

| | | | |
|---|---|---|---|
| Mix | 53.36 | 49-58 | 30-67 |
| Air* (incorporated | 13.34 | 9-17 | 0-36 |
| during freezing) | | | |
| Wafer | 33.30 | 30-35 | 30-35 |
| Total | 100.00 | | |

Without Wafer

| | | | |
|---|---|---|---|
| Mix | 80.00 | 75-85 | 45-100 |
| Air* (incorporated | 20.00 | 15-25 | 0-55 |
| during freezing) | | | |
| Total | 100.00 | | |

*Based on a target overrun of 25% and an overrun range of 0%-120%

2) Frozen Yogurt In A Tub
Mix:

| | Target | Usage | |
|---|---|---|---|
| | Usage | Range | |
| Ingredients | (% w/w) | (% w/w) | Alternate Ingredients |
| Medium | 19.00 | 0-25 | Liquid sucrose, honey, corn |
| invert sugar, | | | syrup, corn syrup solids, high |
| liquid | | | fructose corn syrup, glucose, |
| | | | aspartame, sucralose, xylitol, |
| | | | sorbitol, invert sugar, |
| | | | sweetened fruit preserves, |
| | | | steveoside |
| Cocoa, | 2.61 | 0-10 | Natural or artificial flavours, |
| unsweetened, | | | chocolate liquor |
| with alkali | | | |
| Butter, | 1.81 | 0-20 | Cream, whole milk, |
| unsalted | | | anhydrous milk fat, fat |
| | | | replacers, vegetable oils |
| Skim milk | 7.00 | 0-15 | The liquid, concentrated and |
| powder, low | | | dry forms of: skim milk, whole |
| temperature | | | milk, cream, buttermilk, whey, |
| | | | whey isolate and vegetable |
| | | | proteins including soy. |
| Whey | 5.24 | 0-15 | The liquid, concentrated and |
| Protein | | | dry forms of: skim milk, whole |
| Concentrate | | | milk, cream, buttermilk, whey, |
| | | | whey isolate and vegetable |
| | | | proteins including soy. |
| Whey | 5.24 | 0-15 | The liquid, concentrated and |
| Protein | | | dry forms of: skim milk, whole |
| Hydrolysate | | | milk, cream, buttermilk, whey, |
| | | | whey isolate and vegetable |
| | | | proteins including soy. |
| Yogurt, low- | 13.65 | 0-25 | Yogurt, full-fat; yogurt solids, |
| fat | | | and yogurt cultures such as |
| | | | Streptococcus thermophilus, |
| | | | Lactobacillus bulgaricus and |
| | | | Lactobacillus acidophilus |
| Water | 45.44 | 0-65 | Moisture from liquid dairy |
| | | | ingredients, liquid protein |
| | | | concentrates and/or liquid |
| | | | sweeteners |
| Total | 100.00 | | |

Final Product:

| | | Intermediate | |
|---|---|---|---|
| | Target | Usage | |
| | Usage | Range | Usage Range |
| Ingredients | (% v/v) | (% v/v) | (% v/v) |
| Mix | 73.82 | 67-80 | 45-100 |
| Air* (incorporated | 26.18 | 20-33 | 0-55 |
| during freezing) | | | |
| Total | 100.00 | | |

*Based on a target overrun of 35% and an overrun range of 0%-120%

3) Frozen Chocolate Yogurt Novelty

| | Target | Usage | |
|---|---|---|---|
| | Usage | Range | |
| Ingredients | (% w/w) | (% w/w) | Alternate Ingredients |
| Medium | 19.00 | 0-25 | Liquid sucrose, honey, corn |
| invert sugar, | | | syrup, corn syrup solids, high |
| liquid | | | fructose corn syrup, glucose, |
| | | | aspartame, sucralose, xylitol, |
| | | | sorbitol, invert sugar, |
| | | | sweetened fruit preserves, |
| | | | steveoside |
| Cocoa, | 2.61 | 0-10 | Natural or artificial flavours, |
| unsweetened, | | | chocolate liquor |
| with alkali | | | |
| Butter, | 3.17 | 0-20 | Cream, whole milk, |
| unsalted | | | anhydrous milk fat, fat |
| | | | replacers, vegetable oils |
| Skim milk | 8.62 | 0-15 | The liquid, concentrated and |
| powder, low | | | dry forms of: skim milk, whole |
| temperature | | | milk, cream, buttermilk, whey, |
| | | | whey isolate and vegetable |
| | | | proteins including soy. |
| Whey | 4.72 | 0-15 | The liquid, concentrated and |
| Protein | | | dry forms of: skim milk, whole |
| Concentrate | | | milk, cream, buttermilk, whey, |
| | | | whey isolate and vegetable |
| | | | proteins including soy. |
| Whey | 4.72 | 0-15 | The liquid, concentrated and |
| Protein | | | dry forms of: skim milk, whole |
| Hydrolysate | | | milk, cream, buttermilk, whey, |
| | | | whey isolate and vegetable |
| | | | proteins including soy. |
| Yogurt, low- | 13.65 | 0-25 | Yogurt, full-fat; yogurt solids, |
| fat | | | and yogurt cultures such as |
| | | | Streptococcus thermophilus, |
| | | | Lactobacillus bulgaricus and |
| | | | Lactobacillus acidophilus |
| Water | 43.50 | 0-65 | Moisture from liquid dairy |
| | | | ingredients, liquid protein |
| | | | concentrates and/or liquid |
| | | | sweeteners |
| Total | 100.00 | | |

Final Product:

| | | Intermediate | |
|---|---|---|---|
| | Target | Usage | |
| | Usage | range | Usage Range |
| Ingredients | (% v/v) | (% v/v) | (% v/v) |
| Mix | 100 | 83-100 | 45-100 |
| Air* (incorporated | 0 | 0-17 | 0-55 |
| during freezing) | | | |
| Total | 100.00 | | |

*Based on a target overrun of 0% and an overrun range of 0%-120%

While the present invention has been described with reference to what are presently considered to be the preferred examples, it is to be understood that the invention is not limited to the disclosed examples. To the contrary, the invention is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety.

1. A process for making a protein-fortified frozen dessert formulation comprising
(a) preparing a sweet mix comprising 10-20% w/w sugar, 0-10% w/w flavouring, 0-20% w/w fat, 10-15% w/w milk solids, 0-11% w/w protein and 50-65% w/w water;
(b) preheating the sweet mix to 30-60° C.;
(c) pasteurizing the preheated sweet mix;
(d) homogenizing the pasteurized sweet mix;
(e) cooling to 3-5° C. for 4-16 hours to produce an aged sweet mix;
(f) preparing a final mix of 0-20% w/w yogurt, 70-90% w/w of the aged sweet mix; and 0-10% w/w protein; and
(g) freezing the final mix to prepare a protein-fortified frozen yogurt formulation.

2. The process of claim 1, wherein the preparation of the final mix in step (f) comprises blending the yogurt and aged sweet mix at 5,000 to 7,000 rpms followed by the addition of protein at 9,000 to 10,000 rpms.

3. The process of claim 1, wherein the sweet mix comprises about 19% w/w sugar, about 3% w/w flavouring, about 4% w/w fat, about 10% w/w milk solids, about 10% w/w protein and about 54% w/w water.

4. The process of claim 1, wherein the final mix comprises about 14% w/w yogurt, about 77% w/w aged sweet mix and about 9% w/w protein.

5. The process of claim 1, wherein the final mix comprises about 15% w/w yogurt, about 85% w/w aged sweet mix and about 0% w/w protein.

6. A process for making a protein-fortified frozen dessert formulation comprising
(a) preparing a mix comprising 5-25% w/w sugar, 0-10% w/w flavouring, 0-20% w/w fat, 0-15% w/w milk solids, 0-20% w/w protein, 0-25% yogurt and 0-65% w/w water;
(b) preheating the mix to 30-60° C.;
(c) pasteurizing the preheated mix;
(d) homogenizing the pasteurized preheated mix;
(e) cooling the mix to 3-5° C. for 4-16 hours to produce an aged mix; and
(f) freezing the aged mix to prepare a protein-fortified frozen dessert formulation.

7. The process of claim 6, further comprising freezing in step (f) to a target overrun of 25-55%.

8. The process of claim 6, wherein the mix in step (a) comprises 10-20% w/w sugar, 0-10% w/w flavouring, 0-20% w/w fat, 10-15% w/w milk solids, 5-15% w/w protein, 5-20% yogurt and 50-65% w/w water.

9. The process of claim 6, wherein the mix in step (a) comprises about 19% w/w sugar, about 3% w/w flavouring, about 2% w/w fat, about 7% w/w milk solids, about 11% w/w protein, about 14% yogurt and about 45% w/w water.

10. The process of claim 1, wherein the homogenizing in step (d) is a one-stage or two-stage homogenization.

11. The process of claim 10, wherein the one-stage homogenization is at 2000-3000 PSI.

12. The process of claim 10, wherein the two-stage homogenization is at 2000-2500 PSI, followed by homogenizing at 500-1000 PSI.

13. The process of claim 12, wherein the two-stage homogenization is at 2000 PSI followed by 500 PSI.

14. The process of claim 1, wherein preheating the mix in step (b) is at 55° C.

15. The process of claim 1, wherein pasteurizing in step (c) is by batch pasteurization or continuous pasteurization.

16. The process of claim 15, wherein batch pasteurization comprises pasteurization at 69° C. for 30 minutes.

17. The process of claim 15, wherein continuous pasteurization comprises pasteurization at 80° C. for 25 seconds.

18. The process of claim 1, wherein the sugar is selected from the group consisting of granulated sucrose, liquid sucrose, honey, corn syrup, corn syrup solids, high fructose corn syrup, glucose, invert sugar aspartame, sucralose, xylitol, sorbitol, maple syrup, sweetened fruit preserves, fruit puree, fruit, mallitol, maltitol and stevioside (Stevia).

19. The process of claim 18, wherein the sugar is granulated sucrose.

20. The process of claim 1, wherein the flavouring is selected from the group consisting of cocoa, maple, spices, chocolate liquor, liqueurs, natural and artificial flavours.

21. The process of claim 20, wherein the flavouring is cocoa.

22. The process of claim 1, wherein the fat is selected from the group consisting of butter, cream, whole milk, whole milk powder, anhydrous milk fat, omega fatty acids and fat replacers.

23. The process of claim 22, wherein the fat is butter.

24. The process of claim 1, wherein the milk solids are selected from the group consisting of skim milk powder, skim milk, whole milk, whole milk powder, cream, soy milk, lactose-free milk, buttermilk and buttermilk powder.

25. The process of claim 24, wherein the milk solids are skim milk powder.

26. The process of claim 1, wherein the protein is whey protein, milk protein, albumin, casein, vegetable protein or soy protein.

27. The process of claim 26, wherein the whey protein is selected from the group consisting of whey protein concentrate, whey protein isolate and hydrolyzed whey protein.

28. The process of claim 26, wherein the milk protein is selected from the group consisting of milk protein concentrate, milk protein isolate and hydrolyzed milk protein.

29. The process of claim 26, wherein the soy protein is selected from the group consisting of soy protein concentrate, soy protein isolate and hydrolyzed soy protein.

30. The process of claim 1, wherein the water is in the form of moisture from liquid dairy ingredients and liquid sweeteners.

31. The process of claim 1, wherein the yogurt is selected from the group consisting of low fat yogurt, full fat yogurt, yogurt solids, freeze dried yogurt culture, frozen yogurt culture, yogurt acid flavouring and typical yogurt cultures.

32. The process of claim 31, wherein the yogurt is low fat yogurt.

33. The process of claim 1, wherein the process produces a protein-fortified frozen dessert product having a total protein content of at least 5% w/v protein.

34. The process of claim 33, wherein the total protein content is 8-15% w/v protein.

35. The process of claim 33, wherein the total protein content is calculated from protein from the protein component, milk solids and yogurt in the protein-fortified frozen dessert product.

36. A protein-fortified frozen dessert formulation produced by the process of claims 1.

37. A protein-fortified frozen dessert formulation comprising 8-15% w/w sugar, 0-8% w/w flavouring, 2-15% w/w fat, 8-12% w/w milk solids, 0-20% w/w protein, 0-20% w/w yogurt, 39-50% w/w water and 20%-55% v/v air.

38. A protein-fortified frozen dessert formulation comprising about 15% w/w sugar, about 2% w/w flavouring, about 3% w/w fat, about 8% w/w milk solids, about 17% w/w protein, about 14% w/w yogurt, about 42% w/w water and about 41% v/v air.

39. A protein-fortified frozen dessert formulation comprising 5-25% W/W sugar, 0-10% w/w flavouring, 0-20% w/w fat, 0-15% w/w milk solids, 0-20% w/w protein, 0-25% yogurt, 0-65% w/w water and 0-55% v/v air.

40. The protein-fortified frozen dessert formulation of claim 39 comprising 10-20% w/w sugar, 0-10% w/w flavouring, 0-20% w/w fat, 10-15% w/w milk solids, 5-15% w/w protein, 5-20% yogurt, 50-65% w/w water and 10-40% v/v air.

41. The protein fortified frozen dessert formulation of claim 39 comprising about 19% w/w sugar, about 3% w/w flavouring, about 2% w/w fat, about 7% w/w milk solids, about 11% w/w protein, about 14% yogurt, about 45% w/w water and 0-55% v/v air.

42. The protein fortified frozen dessert formulation of claim 39, wherein the % v/v air is selected from the group consisting of about 0%, about 13%, about 20% and about 25%.

43. The protein-fortified frozen dessert formulation of claim 36, further comprising an emulsifier or stabilizer.

44. The protein-fortified frozen dessert formulation of claim 36, further comprising chocolate chips, caramel, bubblegum, nuts, fruits, vegetables or baked inclusions.

45. The protein-fortified frozen dessert formulation of claim 44, wherein the baked inclusions is selected from the group consisting of cookies, brownies, pie crust pieces, wafer pieces, sugar cone pieces, cookie dough, candies, chocolate bar pieces and crunches.

46. The protein-fortified frozen dessert formulation of claim 36, wherein the total protein content is at least 5% w/v.

47. The protein-fortified frozen dessert formulation of claim 46, wherein the total protein content is 8-15% w/v.

48. The protein-fortified frozen dessert formulation of claim 46, wherein the total protein content is calculated from protein from the protein component, milk solids and yogurt in the protein-fortified frozen dessert product.

49. Use of the protein-fortified frozen dessert formulation of claim 36 for producing a dessert product.

50. The use of claim 49, wherein the dessert product is selected from the group consisting of protein-fortified frozen yogurt sandwiches, protein-fortified frozen yogurt in a tub, protein-fortified frozen yogurt novelties, protein-fortified frozen yogurt drumsticks, protein-fortified frozen yogurt cakes, protein-fortified frozen yogurt sundaes, protein-fortified soft serve frozen yogurt, protein-fortified milkshakes and protein-fortified smoothies.
